(19) United States
(12) Patent Application Publication
(10) Pub. No.: US 2020/0141102 A1
(43) Pub. Date: May 7, 2020

(54) QUICK CONNECT DEVICE AND ASSEMBLY FOR USE WITH A TOILET FILL VALVE

(71) Applicant: KEVIN J. GUTHRIE, Wind Lake, WI (US)

(72) Inventor: KEVIN J. GUTHRIE, Wind Lake, WI (US)

(21) Appl. No.: 16/732,801

(22) Filed: Jan. 2, 2020

Related U.S. Application Data
(62) Division of application No. 15/586,683, filed on May 4, 2017, now abandoned.
(60) Provisional application No. 62/332,219, filed on May 5, 2016.

(51) Int. Cl. E03D 1/32; F16L 19/02; F16L 19/04

(52) U.S. Cl. CPC E03D 1/32; F16K 1/34; F16L 19/04; F16L 19/0218

(57) ABSTRACT

An assembly includes a tubular inlet riser to be mounted within a toilet tank. The tubular inlet riser further includes an inner water bore, a bottom-most portion having an outer threaded portion, and a bottom seat. The assembly further includes a half cartridge adapter, which includes a cylindrical upper tube stop cavity, a cylindrical medial O-ring cavity, and a cylindrical lower cartridge cavity.

### PRIORITY CLAIM

This application is a divisional application of U.S. patent application Ser. No. 15/586,683, filed May 4, 2017, the contents of which are hereby incorporated by reference.

### FIELD OF THE INVENTION

The present invention relates generally to plumbing fixtures and to the component parts that are used in them, including fill valves, tubular inlet risers for fill valves, and assemblies for flush systems used in gravity flush toilets. More specifically, it relates to an improved connection device of the type that is used to secure one end of an inlet water line to the tubular inlet riser of a toilet fill valve, the tubular inlet riser of the fill valve being typically anchored at the bottom of a toilet water tank.

### BACKGROUND OF THE INVENTION

Conventional toilets typically employ a number of essential components. First, a porcelain water tank is mounted immediately above a porcelain bowl from which a quantity of water is rapidly drained in order to flush waste from the bowl into the sewer system. One very common design uses a flapper valve made of an elastomeric material that covers the drain outlet of the tank. When the flush handle on the outside of the tank is manually depressed the flapper valve is lifted via a chain or other connecting means and the head of water in the tank drains through the drain outlet, the drain outlet being normally covered by the flapper valve. The flapper valve is typically designed with an inverted air chamber so that it initially floats as it is lifted away from the drain outlet in the bottom of the tank. This allows sufficient flushing water to flow into the bowl even if the user immediately releases the flush handle. When the water level in the tank drops, the tank is automatically refilled through a fill valve that is connected to a high pressure water supply line.

The typical fill valve for the tank comprises a tubular inlet riser that extends through an opening in the bottom of the tank and is connected to the pressurized water line. Current connections that are available include female compression to female compression with braided stainless steel hose extending between them; female compression to female compression with woven synthetic polyvinyl chloride (“PVC”) hose; copper, stainless steel, or rigid PVC tubing with compression style female fittings, and cross-linked polyethylene, commonly abbreviated PEX, piping with a threaded nut for attachment to the threaded tubular inlet riser.

When the tank drains, a float connected to the ballcock or pilot fill valve descends. This activates the ballcock or pilot fill valve and it begins to refill the tank with water via the inlet riser at a rate that is much slower than the rate at which water flows through the drain outlet. When the tank is nearly empty, the flapper valve closes. The tank continues to refill as the float connected to the ballcock or pilot fill valve rises. At the same time water from the ballcock or pilot fill valve enters an overflow tube and refills the bowl to the normal standing water level to provide a trap seal. Once the float reaches a predetermined height indicating that the tank is full, the ballcock or pilot fill valve completely turns off and the flow of water through the inlet riser stops.

The foregoing general conventional arrangement is still widely used today. In the experience of this inventor, however, there is a need to provide an improved water inflow quick connect device that would make it easier for home owners and plumbers to install the in-flow connection tubing the tubular inlet riser of the fill valve at the point where the tubular inlet riser of the fill valve is anchored to the tank floor.

### SUMMARY OF THE INVENTION

In accordance with the foregoing, an improved construct for making an improved in-flow connection to the tubular inlet riser of a fill valve have been devised by this inventor. In this construct, a “half cartridge” insert is welded in place at the bottom-most portion of the tubular inlet riser of the fill valve. A separate conventional half cartridge assembly, comprised of a pair of O-rings, a retainer, and a locking collar, is used in conjunction with the welded half cartridge insert to complete a similar assembly wherein an end of in-flow connection tubing is secured within the half cartridge insert and the half cartridge assembly.

The foregoing and other features of the quick connect device and assembly of the present invention will be apparent from the following detailed description when read in conjunction with the accompanying drawings.

### BRIEF DESCRIPTION OF THE DRAWINGS

FIG. 1 is a cross sectioned side elevation view of the tubular inlet riser of a fill valve with which a quick connect device and assembly is used with an in-flow connection tubing end, the view showing the elements in an exploded or expanded view.

FIG. 2 is a cross sectioned view of the tubular inlet riser illustrated in FIG. 1 but showing the fill valve and quick connect device as assembled without showing the in-flow connection tubing.

### DETAILED DESCRIPTION

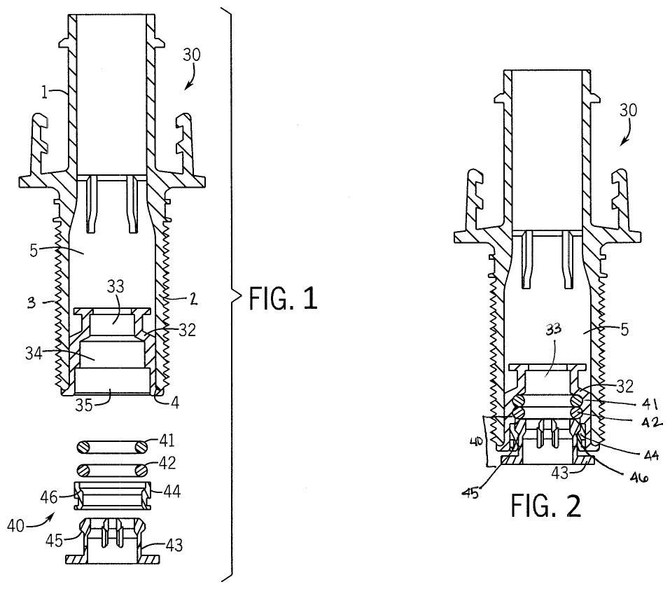

Referring now to FIG. 1, it illustrates a preferred embodiment of a quick connect assembly, generally identified 30, that is constructed in accordance with the present invention. Assembly 30 comprises a tubular inlet riser 1 of the type that would be mounted within a toilet tank where a main control valve assembly would be mounted on the upper end of the inlet riser 1. The inlet riser 1 comprises an inner riser bore 5 and fill water passes through this bore 5 when the tank empties in accordance with the main control valve assembly. The bottom-most portion 2 of the inlet riser 1 comprises an outer threaded portion 3 and a bottom seat 4. Though not shown, threaded portion 3 of the inlet riser 1 is also used to secure the riser 1 to the floor of the toilet tank via a seal and a nut. Those elements are not illustrated, but mentioned for purposes of understanding why the threaded portion 3 extends as far up the bottom-most portion of riser 1 as it does.

In assembly 30, a half cartridge adapter structure 32 is hermetically bonded to the bottom seat 4 of the inlet riser 1 and extends upwardly into the bore 5 of the riser 1. The adapter structure 32 comprises a cylindrical upper tube stop cavity 33, a cylindrical medial O-ring cavity 34, and a cylindrical lower cartridge cavity 35.

Complementary to this adapter structure 32 is a conventional half cartridge subassembly, generally identified 40, for insertion into the O-ring and lower cartridge cavities 34, 35, respectively. The cartridge subassembly 40 comprises a pair of O-rings 41, 42, a retainer 43, and a locking collar 44. The retainer 43 further comprises a plurality of capturing shoulders 45, and the locking collar 44 further comprises a complementary internal circumferential ridge 46. When the shoulders 45 are urged over the ridge 46, the retainer 43 is held firmly in place by the locking collar 44.

Referring now to FIG. 2, it shows the half cartridge subassembly 40 fully inserted into the adapter structure 32. As can be seen in FIG. 2, half cartridge subassembly 40 is inserted into the adapter structure 32 such that a base of half cartridge subassembly 40 is brought into close proximity to the bottom seat 4 of riser 1. Further, as described above, shoulders 45 are moved or urged over ridge 46, such that the retainer 43 is held in place by locking collar 44.

In assembly, one end of a tube, hose, or conduit (not shown) is inserted into the retainer 43. In a preferred embodiment, the tube, hose, or conduit would comprise PEX (a form of polyethylene with cross-links) tubing. The pair of O-rings 41, 42 are inserted into the O-ring cavity 34 and the locking collar 44 is inserted into the lower cavity 35. The retainer 43, with the tube, hose, or conduit attached, is inserted into the locking collar 44 sufficiently that the end of the tube, hose, or conduit extends upwardly into the adapter structure 32 and the retainer 43 engages the locking collar 44, which exerts clamping pressure on the tube, hose, or conduit to capture it and hold it in place. The O-rings 41, 42 complete the water-tight seal of the assembly. Again, see FIG. 2.

In accordance with the foregoing, it will be apparent that a construct for making an improved in-flow connection to the tubular inlet riser has been devised. The construct utilizes a half-cartridge assembly and allows for ease of installation of the in-flow connection tubing to the tubular inlet riser of the fill valve.

1. An assembly comprising:
a tubular inlet riser adapted to be mounted within a toilet tank, the tubular inlet riser further comprising:
an inner water bore;
a bottom-most portion having an outer threaded portion; and
a bottom seat; and
a half cartridge adapter, the half-cartridge adapter further comprising:
a cylindrical upper tube stop cavity;
a cylindrical medial O-ring cavity; and
a cylindrical lower cartridge cavity.

2. The assembly of claim 1, wherein the half cartridge adapter is hermetically bonded to the bottom seat of the tubular inlet riser.

3. The assembly of claim 1, wherein the half cartridge adapter extends upwardly into the inner water bore of the tubular inlet riser.

4. The assembly of claim 1, further comprising a half cartridge subassembly, wherein the half cartridge subassembly further comprises:
a pair of O-rings;
a retainer; and
a locking collar.

5. The assembly of claim 4, wherein:
the retainer further comprises a plurality of capturing shoulders; and
the locking collar further comprises an internal circumferential ridge.

6. The assembly of claim 5, wherein the internal circumferential ridge holds the retainer in place when the half cartridge subassembly is inserted into the half cartridge adapter.

7. The assembly of claim 1, wherein:
the pair of O-rings are inserted into the cylindrical medial O-ring cavity; and
the locking collar is inserted into the cylindrical lower cartridge cavity.
